(19) United States
(12) Patent Application Publication
(10) Pub. No.: US 2013/0081283 A1
(43) Pub. Date: Apr. 4, 2013

(54) COMPOSITE KNIFE BLADE

(71) Applicant: KAI U.S.A., LTD. DBA KERSHAW KNIVES, Tualatin, OR (US)

(72) Inventor: Darrell Lewis, Lexington, KY (US)

(73) Assignee: KAI U.S.A., LTD. DBA KERSHAW KNIVES, Tualatin, OR (US)

(21) Appl. No.: 13/686,661

(22) Filed: Nov. 27, 2012

Related U.S. Application Data
(63) Continuation of application No. 11/760,624, filed on Jun. 8, 2007.
(60) Provisional application No. 60/911,453, filed on Apr. 12, 2007.

(51) Int. Cl. B26B 9/00; B23K 26/38; B23P 15/28

(52) U.S. Cl. CPC B26B 9/00; B23P 15/28; B23K 26/38
USPC 30/350; 76/104.1; 219/121.72; 148/528

(57) ABSTRACT

A composite knife blade includes a cutting-edge piece of a first alloy, a back piece of a second alloy different from the first alloy, the cutting-edge piece and the back piece are brazed together at a serpentine joint. The cutting-edge piece has a high Rockwell hardness value, as compared to a hardness of the back piece. A method of manufacture of the knife blade includes fine blanking the back piece of from a sheet of the second alloy, laser cutting the cutting-edge piece from a sheet of the first alloy, and brazing the first piece to the second piece to form a composite blade. The composite blade is then cooled from the brazing temperature to an austenizing temperature of the cutting-edge piece, and quenched, to harden the cutting-edge piece.

### CROSS-REFERENCE TO RELATED APPLICATIONS

This application is a continuation application of U.S. application Ser. No. 11/760,624, filed Jun. 8, 2007, which claims the benefit of U.S. Provisional Patent Application No. 60/911,453, filed Apr. 12, 2007, the entire disclosures of which are herein incorporated by reference for all purposes.

### Technical Field

The present disclosure relates generally to knife blades, and in particular to knife blades composed of two or more dissimilar materials.

### BACKGROUND

Knives are used as tools in countless industries and applications, and are available in a vast array of shapes, sizes, and configurations. Most knives, however, share some characteristics in common. Typically, knives include a blade, usually metal, with a sharpened edge, and a handle to which the blade is attached and by which a user can grasp the knife. Higher quality knife blades are generally characterized their ability to take and hold an edge for extended periods of use. A knife that loses its edge quickly and must be sharpened frequently is of limited use except to the most casual user. Accordingly, there is continual and ongoing effort to develop new and better materials and treatments to improve the quality of knife blades, and to produce knives that can be sharpened to a finer edge and hold the edge.

Edge retention is generally a matter of edge geometry and material hardness. While there are some non-steel, and even non-metallic knife blades available, most blades are made from steel, and, increasingly, from stainless steel. In order to achieve a high degree of hardness, knife manufacturers typically harden the steel from which their blades are made, usually by heat treatment. However, there is a more or less direct relationship between hardening of a given alloy and brittleness, meaning that a knife blade having an extremely high degree of hardness will generally also be more easily breakable than other knives. In recent years, advances in metallurgy have produced steel alloys that are inherently harder than more commonly used alloys, and that can be further hardened to a much higher degree than other more commonly used blade steels, but these new and specialized alloys can be significantly more expensive, and knives made from such steels, that are fully hardened to take advantage of their unique properties, are often susceptible to accidental breakage. Thus, the knife manufacturer must find a compromise between hardness and toughness. Depending upon the intended application of the knife, or the intended market, a knife having a harder, longer lasting edge may be more important than the less expensive, more durable one.

This is particularly the case with certain higher quality folding knives, and knives made for professional chefs and others who prepare food, which are often in constant use.

In the case of very high quality hand-made knives, the blacksmith may, after hardening the blade, subject the blade to additional heat treatment designed to draw the hardness out of the back, or spine, of the blade, while allowing the edge to remain hard. This provides the blade with a relatively more flexible back and a hard cutting edge. The tougher back portion of the blade supports and protects the more fragile cutting edge, and reduces the likelihood that the blade will break accidentally or catastrophically. Unfortunately, such differential heat treating processes are labor-intensive and would be prohibitively expensive to employ in manufacturing knives for the mass market.

Knife blades are manufactured by a number of different processes, depending upon a variety of factors, including the materials used in the manufacturing process, and the desired quality of the finished product. Fine blanking is a widely used process that provides a number of benefits to the manufacturer. Fine blanking employs a press to form knife blades from flat sheets of material. In a three step punching process, the material is first clamped in place, then pressed between upper and lower parts of a fine blanking die that forms and separates the knife blade blank from the parent sheet, then the finished blank is ejected from the blanking die. The fine blanking process produces a knife blank that requires very little additional machining or other finish steps. Pivot holes and other features can be formed in a blade to very close tolerances during the same process, and, frequently, edge grinding is the only step remaining to finish the blade, although in some cases there may also be a slight burr on one side of the blade that is removed very easily. Unfortunately, fine blanking is not suitable for extremely hard materials, and many of the alloys that are especially suitable for a knife blade cannot be fine blanked, inasmuch as the harder steel quickly degrades or destroys the blanking die used to form the blades. In the case of steels that are too hard for fine blanking, computer driven laser cutting is one common method for forming blades from harder steels, in which a laser traces the outline shape of the blade, cutting the blank from the parent sheet. After the knife blank is cut out, further machining is performed to finish the edges, pivot holes, and other features of the blade. This process is significantly more time-consuming and expensive than the fine blanking process, which limits the practicality of using very hard alloys for any but the most expensive knives.

U.S. Pat. No. 4,896,424, to Walker, is directed to folding knife with a blade having two sections, in which one section of the blade is made from titanium, while the second section of the blade, which includes the blade edge, is made from a high-carbon stainless steel. The sections are joined by a running dovetail joint. The sections are cut by wire EDM (electrical discharge machining), with the dovetails cut for a friction fit, so that the sections can be joined only by being pressed together, as with an arbor press. Once the sections are pressed together, they are peened, i.e., the joint is hammered to deform the metal of the sections, to make a permanent joint.

However, there are some drawbacks that arise with Walker's method. First, wire EDM is an expensive process for mass production, especially for parts that include holes, such as the tang of a folding knife. Second, the dovetail edges of the blade sections must be cut to very close tolerances to be sufficiently close for a good press-fit, without being so tight that they bind, which is expensive. Third, the press-fitting and peening operations are labor intensive and expensive for a mass production product.

U.S. Pat. No. 6,70,627, to Korb et al., is directed to a composite utility knife blade having a cutting edge from a wire of tool steel welded to an alloy steel backing strip. A continuous ribbon of the backing steel is rolled from a spool and welded, by EBW (electron beam welding), to a wire of tool steel as the ribbon and wire pass under the electron beam, and is then recoiled. The resulting composite ribbon is required to be subjected to a number of additional steps, including anneal, punch and score, straighten, heat treat and temper, grind, and hone before it is finally separated into separate blades. Unfortunately, these processes are not suitable for manufacturing knife blades of the kind discussed above.

### BRIEF SUMMARY

According to one embodiment, a composite knife blade is provided, including a cutting-edge piece of a first alloy, a spine piece of a second alloy different from the first alloy, and a brazed joint between the cutting-edge piece and the spine piece. The cutting-edge and spine pieces are interlocked at the joint providing additional mechanical strength to the joint. The brazed joint includes a brazing material such as, for example, copper, bronze, gold, silver, or nickel. The cutting-edge piece has a high Rockwell hardness value, as compared to a hardness of the back piece.

According to another embodiment, a method of manufacture of a knife blade is provided, including fine blanking a first piece of a knife blade from a sheet of a first material, laser cutting a second piece of the knife blade from a sheet of a second material, harder than the first material, and brazing the first piece to the second piece to form a composite blade.

### BRIEF DESCRIPTION OF THE SEVERAL VIEWS OF THE DRAWINGS

FIG. 1 is a side elevation view of a folding knife according to an embodiment of the invention.

FIGS. 2-6 illustrate components of the blade of the knife of FIG. 1, at various stages of manufacture.

FIG. 7 is a diagrammatic representation of a cutting step in a blade manufacturing process.

FIGS. 8-11 and 13 show blades of folding knives according to respective embodiments of the invention.

FIGS. 12A and 12B are cross-sectional views of the blade of FIG. 11, taken along lines 12-12.

FIG. 14 is a side elevational view of a blade of a fixed-blade knife, according to an embodiment of the invention.

### DETAILED DESCRIPTION

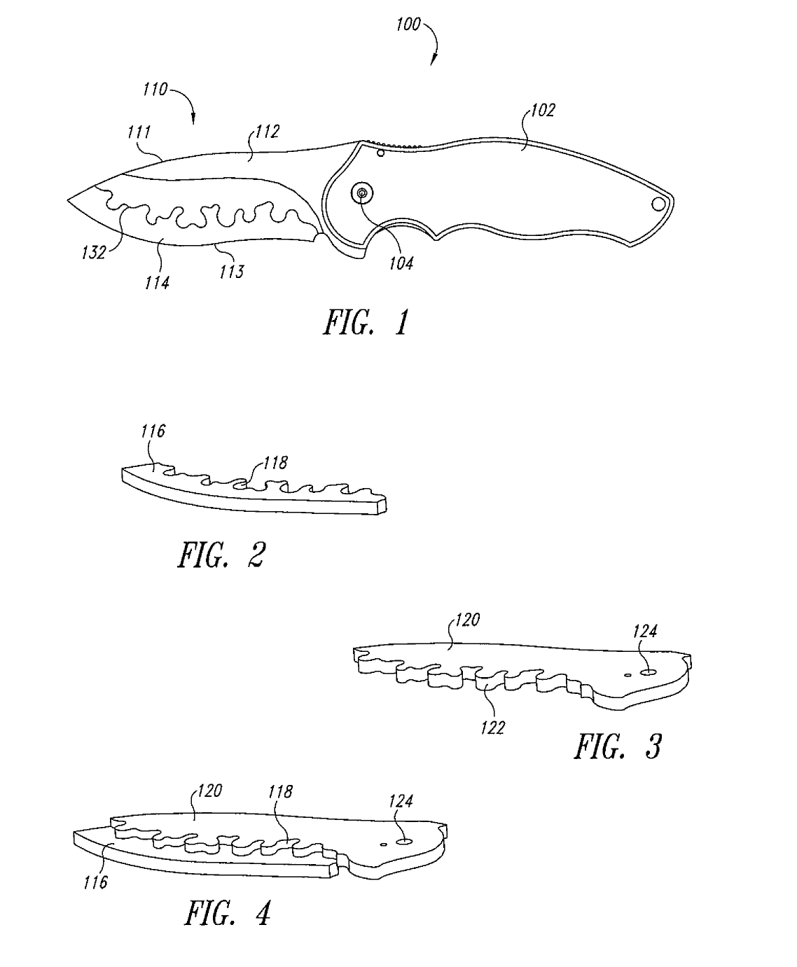

FIG. 1 shows a folding knife 100 according to an embodiment of the invention, comprising a handle 102 and a composite blade 110. The blade 110 is coupled to the handle by a fastener 104 and configured to pivot around the fastener 104 between an open and a closed position. The blade 110 includes a back piece 112, comprising the spine 111 of the blade 110, and a cutting-edge piece 114, comprising the sharpened cutting-edge 113 of the blade. The back and cutting-edge pieces 112, 114 are formed from dissimilar metal alloys and joined at a serpentine joint 132. The materials of the back and cutting-edge pieces 112, 114 are selected according to a number of criteria. Preferably, the back piece 112 is of an alloy that has a high degree of toughness so that it can tolerate stresses like those arising, for example, from flexing and sharp impacts. The back piece 112 may be selected, for example, from among common and relatively inexpensive alloys that have the desired characteristics. The cutting-edge piece 114 is selected from among alloys that are harder or can be hardened to a high degree for improved cutting-edge retention. For example, the back piece, according to an embodiment, is formed from 440A stainless steel, while the cutting-edge piece is formed from a harder steel such as, for example, AST-34, CPM-S30V, VG-10, ZDP-189, D-2, tool steel, etc.

Referring now to FIGS. 2 through 6, a process for manufacturing the composite blade 110 of FIG. 1 will be discussed in detail, according to one embodiment. FIG. 2 shows a cutting-edge blank 116 from which the cutting-edge piece 114 will be formed. The cutting-edge blank 116 is cut from its parent stock using a high-powered CNC (computer numerical control) laser. The cutting-edge piece 116 may also be produced using other appropriate methods including, for example, EDM (electrical discharge machining), water jet cutting, plasma cutting, etc. The cutting-edge blank 116 is provided with a convoluted, or serpentine joining edge 118.

FIG. 3 shows a back blank 120, from which the back piece 112 is formed. The back blank 120 is preferably formed by a fine blanking process, and is provided with a serpentine joining edge 122 configured to interlock with the edge 118 of the cutting-edge blank 116. The back blank 120 may also be formed using other appropriate means, including laser, EDM, water jet, plasma, etc. The back blank 120 is provided with features necessary to mount the blade to a handle, such as a pivot aperture 124, as well as any feature necessary to engage locking elements, stop pins, etc. Only the pivot aperture 124 is shown in detail, and it will be understood that the features will vary according to the particular design of the knife. For example, a blade for a fixed-blade knife may include an extended tang with apertures provided for rivets, as discussed later with reference to FIG. 14. In the embodiment illustrated in FIGS. 1-6, the interlocking serpentine profiles of the joining edges 118, 122 of the cutting-edge blank 116 and back blank 120 provide for simplified assembly, hold the pieces together during a joining process, and enhance the strength of the final product. Additionally, the particular design of the interlocking pattern can be selected for aesthetic appeal, as well. Nevertheless, it is not essential that the edges mechanically interlock; for example, the joining edges of the back and cutting-edge blanks can be formed to generally mate together without interlocking, such as along an essentially straight or simple curved line, and butted together for joining.

As shown in FIG. 4, the serpentine joining-edge profiles of the back and cutting-edge blanks 116, 120 are formed with a slip fit so that they can be easily assembled by hand, while having a sufficient contact for proper flow of brazing metal. A brazing paste is applied at the joining edges 118, 122, either by applying the paste to one of the edges 118, 122 prior to assembly, or by placing a small amount of brazing paste on an upper surface of the back and cutting-edge blanks 120, 116 after they are assembled. The assembled blanks are placed into an oven and heated, preferably, to a temperature about 50° above the liquidus temperature of the brazing material. For example, the liquidus temperature of copper is about 1,980°, so with a copper brazing paste, the blanks are heated to a temperature of about 2,030°. The copper liquefies and flows into the joint 132 by capillary action to form the brazed joint, producing a blade blank 130, as shown in FIG. 6. Brazing in a vacuum oven under partial pressure or in an inert atmosphere generally obviates the need for flux in the paste.

According to an embodiment of the invention, the blade blank 130 is allowed to cool to the austenitic temperature of the alloy from which the cutting-edge blank 116 is formed, where it is held for a short time to stabilize, and then quenched to harden the steel of the cutting-edge blank 116. Following quenching, the blade blank 130 may be reheated to an appropriate tempering temperature and held, then slowly cooled, to temper the blade blank 110. According to one embodiment, the back blank is cut from 440A stainless steel, while the cutting-edge blank is cut from D-2 stainless steel, and they are brazed at about 2,030° using copper brazing material. The resulting blade blank is cooled to the austenizing temperature of D-2 steel, about 1850°, and held at that temperature for about 30 minutes, then quenched. At this point, the D-2 steel has a hardness of about 63 Rockwell, but is very brittle. The blank is then reheated to the primary tempering temperature of the D-2 steel, about 350°, and held at that temperature for about two hours, then slow cooled. The reheating step is repeated several times to fully temper the blade. After the tempering is complete, the D-2 steel will have a hardness in the range of 58-62 Rockwell, while the 440A steel will have a hardness of about 50 Rockwell.

The austenitic temperature and the methods of quenching and tempering will vary in accordance with the materials chosen for the cutting-edge of the blade and the desired hardness and toughness of the finished blade. Some alloys cannot be hardened by heat treatment, others do not require a rapid quench to harden, but will “air harden” as the steel cools more slowly. The alloys used for the back blank 120 and cutting-edge blank 116 can be selected such that the back blank 120 will not harden during the process that hardens the cutting-edge blank 116, or they may be selected such that the tempering process will significantly reduce the degree of hardness imparted to the back blank 120 during the hardening process, as in the example described above. The result is a differentially hardened blade having excellent toughness imparted by the back piece 112, as well as extremely high edge retention provided by the harder cutting-edge piece 114. FIG. 6 shows the blade 110 after final cutting-edge grinding and polishing.

In some cases it may be advantageous to perform an annealing process before the hardening step, in which case, the blade is subjected to a slow cooling process from the austenitic temperature, rather than the quench or uncontrolled cooling. The blade may then be reheated for hardening after the annealing step, if necessary.

In the embodiment illustrated in FIGS. 1-6, it can be seen that the back blank 120 remains largely unmodified in the final blade 110, with only a portion adjoining the cutting-edge piece 114 being removed by the grinding and polishing process. The fine blanking process used to form the back blank 120 generally eliminates the finishing steps that would be necessary in the case of a laser-cut blade, so the manufacturer benefits from the economies of the fine blanking process, while producing a blade that has the cutting-edge qualities of the harder steel of the cutting-edge piece 114. Additionally, the cutting-edge piece represents only a small fraction of the total material used to produce the blade 110. This is advantageous because many of the alloys that have the most desirable cutting-edge characteristics are significantly more expensive than the more conventional alloys that are suitable for the back piece 112. While in the embodiment pictured in FIGS. 1-6 the cutting-edge piece 114 extends some distance across the width of the blade, the process described above can easily be employed to join a much narrower cutting-edge piece to the back piece, inasmuch as the actual cutting edge is a vanishingly small part of the blade.

Another benefit of the method described is that by forming the joining edges 118, 122 of the back and cutting-edge blanks 116, 120 for slip-fit assembly, mass production of the blade 110 is simplified. The brazing process easily fills the narrow gap that results.

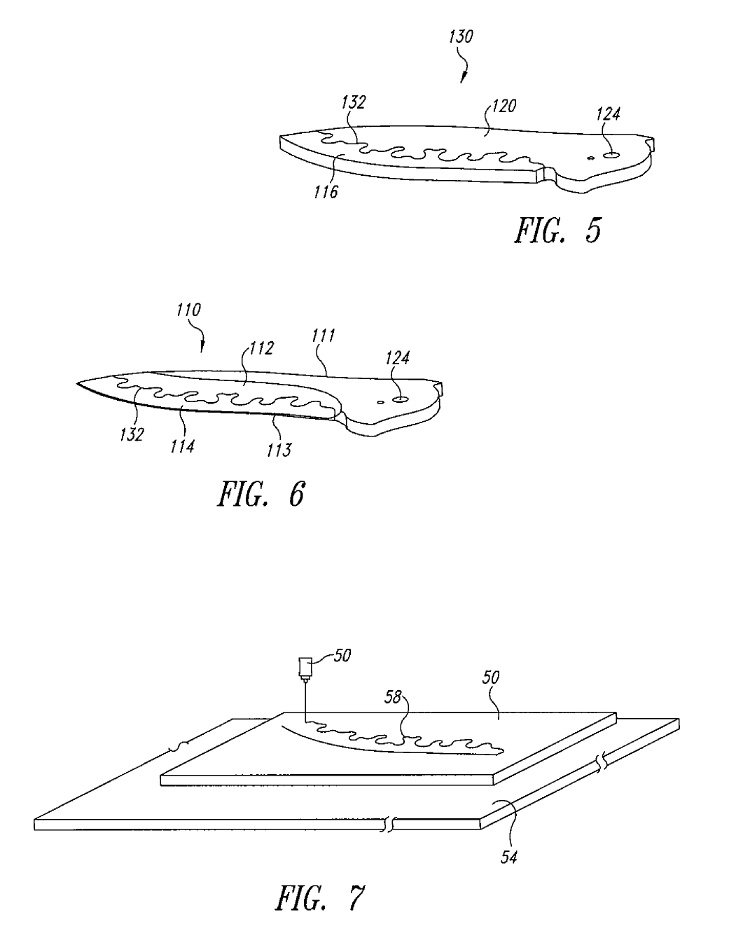

As illustrated diagrammatically in FIG. 7, a laser 50 of the type used to cut parts such as for knife blades is typically positioned above a platen 54 on which the parent stock 56 is arranged. The laser 50, the platen 54, or a combination of both, are moved under computer control relative to each other so that the laser traces the outline of the shape being cut. The heat of the laser melts or vaporizes the metal as it moves, leaving a kerf 58 of varying widths, depending on the speed of the relative movement, the distance of the laser 50 from the material 56, the angle of the cut through the material, attenuation or occlusion of the cutting beam by vapor and material being ejected from the kerf, and other factors. As a result, the edge of the part is not perfectly consistent or smooth, and generally requires at least some machining such as milling, grinding or the like to finish and bring it to acceptable tolerances for use in a finished product.

The result is that, at least with respect to high-speed operations used for economical production cutting of knife blades, a laser cut blade is considered a rough product and generally cannot be assembled as a component in a knife until further machining or smoothing has been performed.

In one embodiment of this invention, both the back piece and the cutting edge piece are laser cut. Then, without any further machining, milling or grinding, the two parts are bonded together to make a knife blade, which is then finished as though it had been cut as a single piece. In another embodiment, the cutting edge is laser cut and the back piece is fine blanked or stamped. The two parts are then joined together according to the principles of this invention without further machining, milling or grinding of the joining edges of either part. This is unexpected because the two parts were made by very different processes and have different tolerances and different finishes on their mating edges. This also provides a substantial cost and time savings because with this invention, a laser cut part does not need to go through the previously required machining or milling steps before being joined as a component of the knife. The savings is even greater because this permits the mating edges of the laser part to be made any desired shape or length without regard to the need to consider post laser machining or milling steps. Thus, the joining edge of the laser cut part can be made serpentine, with each under cut, reverse cuts, convolutions or any shape that a computer controlled laser can trace over the surface without regard as to whether a machining tool is able to later follow this same trace. Some shapes which could not be machined or shapes which would be expensive and time consuming to machine can now be used in the final product, which was not previously practical, and in some cases not possible.

The design and shape of the mating joint can therefore be selected based on designed strength, aesthetics, and other features without concern for the ability to machine the part initially or even machine it after a laser cutting.

Thus, in one embodiment, both the back and cutting-edge pieces were cut using an industrial CNC driven laser as described above. In other embodiments, one part is formed by fine blanking or stamping and the other part by a different technique such as laser, EDM, ion milling, plasma cutting and the like.

In tests conducted by the inventor, composite blades formed substantially as described above exhibited superior characteristics of strength and toughness, and the joints were found to be stronger than the steel of the blades, such that efforts to cause the pieces to separate invariably resulted in bending or breaking one or both of the pieces, instead of separating them at the joint. It is surmised that this is due, at least in part, to the large contact surface area of the joint, and to the fact, because of the serpentine shape, that there is no single line along which more than a small fraction of the joint can be subjected to concentrated stress.

The brazing paste may be copper based, as described above, or it may be formulated with any of a wide range of available materials, including, for example, bronze, nickel, silver, gold, etc. After the blade has been polished, the joint 132 shows, if at all, as a thin hairline on the blade. The brazing metal may be chosen to minimize the visibility of the joint 132 or to enhance it. For example, a copper braze shows as a thin reddish line, while a nickel based braze will have a color that closely matches most stainless steels. According to an embodiment, the blade is subjected to sandblasting, beadblasting, and/or etching. Such treatments will affect the different alloys of the back and cutting-edge pieces 112, 114 differently, changing their respective appearances. For example, sandblasting or beadblasting can be applied at a force sufficient to add a texture to the surface of the relatively more ductile back piece, without affecting the harder surface of the cutting-edge piece 114, or it may be applied with greater force to texture both pieces. The blade may also be chemically etched to change the surface texture or color of one or both of the pieces, or of the brazing metal, depending on the specific alloys of the blade and the chemicals used.

The brazing compound may also be selected to accommodate specific requirements of the materials selected for the blade. For example, some steel alloys have an austenitic temperature in the range of 2,100°. If such an alloy were brazed using the copper braze described above, then later heat hardened, the copper braze would flow out of the joint at the higher austenizing temperature. To avoid such problems, the cutting-edge blank could be hardened prior to the brazing step, but a more economical process would be to use a nickel brazing paste, for which the liquidus temperature is about 2,200°, permitting the brazing and hardening to be performed in the same heating step.

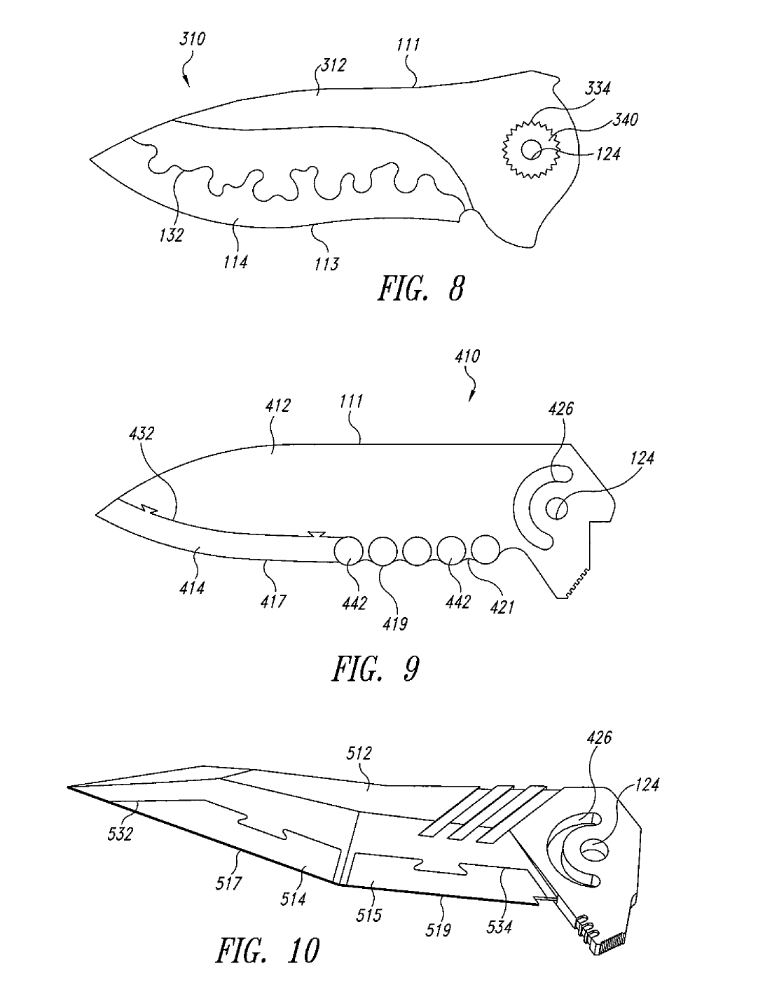

Principles of the invention have been described above with respect to a blade having two dissimilar alloys. According to other embodiments, three or more pieces with separate characteristics may be joined to form a composite blade. FIG. 8 shows a blade 310 having a back piece 312, a cutting-edge piece 114, and a pivot piece 340 positioned in a tang of the blade 310. The back and cutting-edge pieces 312, 114 are substantially as described with reference to FIGS. 1-6, while the pivot piece 340 is formed of a low-friction bronze material and includes the pivot aperture 124. The bronze material of the pivot piece 340 receives the clamping pressure of the pivot fastener and permits rotation of the blade with greatly reduced friction, obviating the need for separate bushings in the pivot mechanism, making assembly of the finished knife simpler. The bronze pivot piece 340 can be fine blanked or formed by any other suitable method to engage the back piece along a joint 334.

FIG. 9 shows an embodiment in which a knife blade 410 includes a back piece 412 of a first alloy, a cutting-edge piece 414 of a second alloy, and serration plugs 442 of a third alloy. The blade also includes a pivot channel 426 that will engage a stop pin in the assembled knife to limit the range of travel between the open and closed positions of the blade 410. Serrated or partially serrated knives are popular for many applications. In general, serrated blades are more difficult to sharpen than non-serrated blade, and they tend to become dull most quickly along the outermost cutting-edges of the serrations. In the embodiment of FIG. 9, the back piece 412 and cutting-edge piece 414 are formed substantially as described above. Additionally, the serration plugs 442 are formed of an alloy that has a hardness that would be so high as to be unsuitable even for the cutting-edge pieces previously described, due to its brittleness, but is advantageous in the small plugs, due to its high hardness and cutting-edge retention.

FIG. 10 shows a knife blade 510 having a complex and fanciful design. The blade 510 includes a back piece 512 and first and second cutting-edge pieces 514, 515 joined, respectively, at joints 532, 534. The blade 510, with its complex shape and fine detail, can be manufactured economically, by fine blanking of the back piece 512, while still providing the desirable cutting-edge characteristics of the harder alloy cutting-edge pieces 514, 515. Additionally, the first and second cutting-edge pieces 514, 515 can themselves be made from dissimilar alloys so as to provide cutting-edges having different hardnesses or appearances.

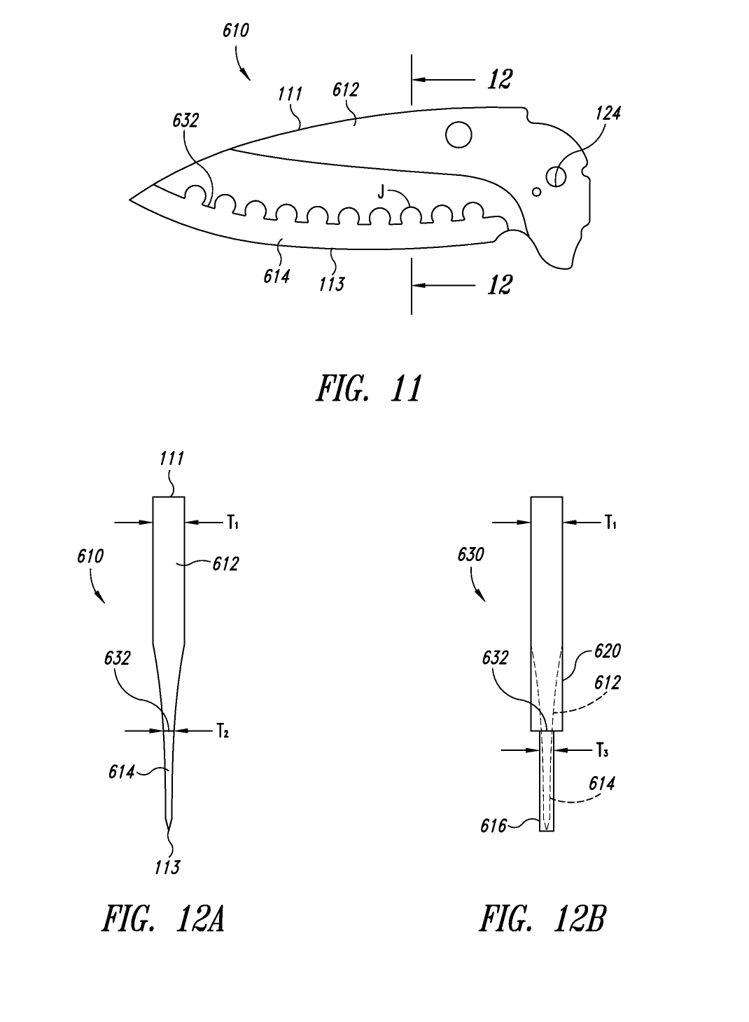

FIG. 11 shows a completed knife blade 610 according to an embodiment of the invention. The blade 610 includes a back piece 612, including the spine 111, and a cutting-edge piece 614, including the sharpened edge 113, mated at a joint 632 having a serpentine shape. FIG. 12A is a cross-sectional view of the blade 610 of FIG. 11, taken along lines 12-12, with the joint 632 intersecting the plane of the cross-section 12-12 at point J of FIG. 11. At its widest point T₁, the back piece 612 has a thickness of around 0.125″, while the cutting-edge piece 614, at its widest point T₂, has a thickness of about 0.042″.

FIG. 12B shows a cross section of a blade blank 630 from which the blade 610 is formed, taken along the same plane in the blank 630 as that defined by lines 12-12 in the blade 610 of FIG. 10. The blade blank 630 includes a back blank 620 and a cutting-edge blank 616 joined, in FIG. 12B, at 632. The dashed lines in FIG. 12B show the profile the blade 610 will take after the grinding and polishing steps, as illustrated in FIG. 12A. It can be seen, with reference to FIGS. 12A and 12B, that it is not necessary to provide the cutting-edge blank 616 with a thickness equal to the thickness of the back blank 620. Accordingly, the back blank 620 is fine blanked substantially to its finished thickness of 0.125″, while the cutting-edge blank 616 is cut from a thinner parent stock having a thickness T₃ of around 0.045″, for example. Using thinner parent stock reduces the material costs for the manufacturer and also the processing costs, inasmuch as there is less material to remove in the grinding step. Additionally, it is possible to fine blank the back blank 620 substantially to the final profile shown in FIG. 12A, so that only the cutting-edge blank 616 needs to undergo significant grinding.

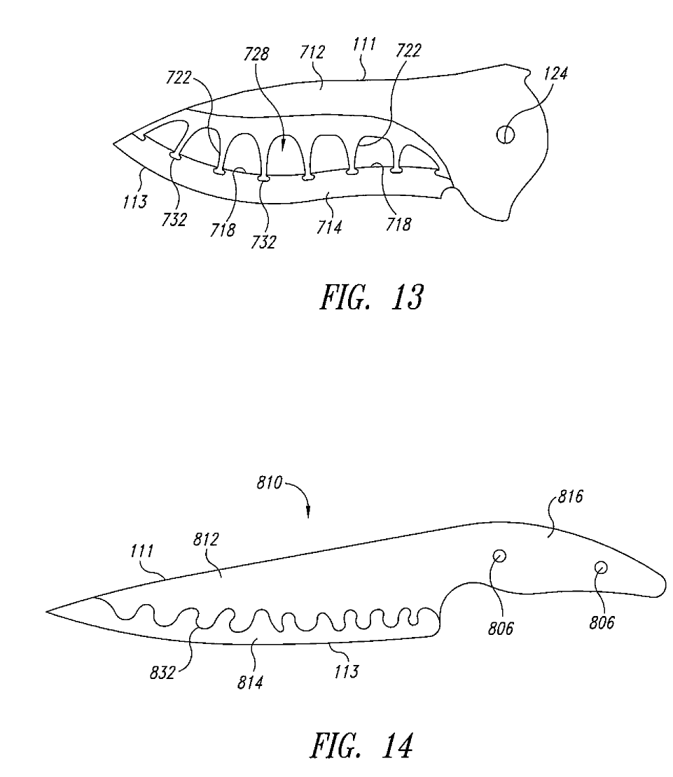

FIG. 13 shows a blade 710 according to one embodiment, having a back piece 712 and a cutting-edge piece 714. The edge 722 of the back piece 712 has a shape that meets and engages the edge 718 of the cutting-edge piece only at intervals, such that the joint 732 is discontinuous, resulting in a plurality of apertures 728 in the finished blade 710. Such apertures may be provided for weight or design considerations, and are produced as a result of the relative shapes of the edges 722, 718 of the back and edge pieces 712, 714, respectively.

According to another embodiment, apertures through the blade are formed that are wholly within the back piece, such that, while the finished blade has apertures, the joint of the blade is continuous.

FIG. 14 shows a blade 810 of a fixed-blade knife, configured, in the illustrated embodiment, for use in preparing food. The blade 810 includes a back piece 812 and a cutting-edge piece 814 bonded together at a brazed joint 832 substantially as described with reference to the embodiment of FIGS. 1-6. A full tang 816 is provided with apertures 806 to receive fasteners that will affix handle scales to opposite sides of the tang. The advantages afforded by the two-piece blade 810 are especially beneficial in kitchen knives. Professional chefs require very sharp knives, which they use constantly. Many prefer to have them sharpened professionally, which may be a considerable expense for chefs who routinely use a number of different knives. Such knife users may spend a great deal of money to obtain knives with very hard, long lasting cutting-edges, not only because of the expense of sharpening, but also because of the inconvenience and frustration they experience when they find it necessary to use a knife with a poor cutting-edge until it can be resharpened. Additionally, the hard use that such knives receive in the kitchen, as well as the fact that many such knives are quite long and narrow, makes them especially susceptible to breaking. Thus, a kitchen knife made in accordance with the disclosed embodiments, that will provide a harder cutting-edge and a tougher blade overall, will help reduce both of the issues that are of greatest concern to those who employ such knives.

Various embodiment have been described in which separate parts are joined using a brazing process. While this is a preferred method, other joining methods may also be employed, including EBW and HIP (hot isostatic press) cladding. The brazing process provides a number of advantages over these and other joining methods: the blanks can be heat treated or annealed in the same heating process that is used to braze the pieces; a large number of blade blanks can be brazed in an oven simultaneously, while EBW would require a CNC driven system to individually weld each blade, which would be much more time consuming and expensive, while the HIP cladding process requires a specialized pressure chamber that is very large relative to the size of the working space in the interior, and requires special treatment and handling of the blanks to prepare them for the process.

There are a number of terms used in describing characteristics of knife blades and the steel from which they are made. These include hardness, the relative ability of a material to resist plastic deformation; tensile strength, the degree to which a material resists a pulling stress without breaking; toughness, the degree to which a material resists stress in general (tensile, compressive, or shear) without fracturing; ductility, the ability of a material to undergo plastic deformation without fracturing; yield strength, the degree to which a material resists a pulling stress without undergoing plastic deformation; and brittleness, the degree to which a material fractures in response to stress, without first deforming.

The abstract of the present disclosure is provided as a brief outline of some of the principles of the invention, according to one embodiment, as an aid to searching. The abstract is not intended as a complete or definitive description of any embodiment thereof, nor should it be relied upon to define terms used in the specification or claims. The abstract does not limit the scope of the claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A knife blade comprising:
a cutting-edge piece of a first material, the cutting-edge piece including a sharpened cutting-edge and a serpentine joint edge different from the cutting-edge;
a back piece of a second material different from the first material, the back piece including a spine edge and a serpentine joint edge, wherein the serpentine joint edge of the back piece is interlocked with the serpentine joint edge of the cutting-edge piece; and
a brazed joint having brazing material positioned between the serpentine joint edges of the cutting-edge piece and the back piece, the brazing material selected from among copper, bronze, gold, silver, and nickel, wherein the brazed joint has a serpentine shape as viewed in a side elevation,
wherein a space is provided between the serpentine joint edge of the back piece and the serpentine joint edge of the cutting-edge piece to have enabled a slip-fit assembly of the cutting-edge piece and the back piece along only a direction perpendicular to a side surface of the knife blade to hold the back piece and the cutting-edge piece together, and to have ensured proper brazing of the back piece to the cutting edge piece.

2. The knife blade of claim 1 wherein the first material is a first alloy having a first Rockwell hardness value and the second material is a second alloy having a second Rockwell hardness value, lower than the first Rockwell hardness value.

3. The knife blade of claim 1, comprising an additional piece brazed to at least one of the cutting edge piece and the back piece.

4. The knife blade of claim 3 wherein the additional piece is fully enclosed by the back piece in a tang of the blade, and includes a pivot aperture extending from one side of the blade to a second side thereof.

5. A method, comprising:
forming a first piece of a knife blade from a sheet of a first material, including forming a serpentine joint edge;
forming a second piece of the knife blade from a sheet of a second material, different from the first material, including forming a spine edge and a serpentine joint edge having a serpentine shape as viewed in a side elevation, the serpentine joint edge of the second piece being configured to interlock with the serpentine joint edge of the first piece, a space provided between the serpentine joint edges of the first and second pieces to permit a slip-fit assembly of the pieces and to ensure proper brazing of the second piece to the first piece;
interlocking the serpentine joint edge of the first piece with the serpentine joint edge of the second piece along only a direction perpendicular to a side surface of the knife blade to hold the first and second pieces together in a slip-fit arrangement that corresponds to a finished knife blade and having the space between the first piece and the second piece;
brazing the first piece to the second piece to form a composite blade including filling the space between the serpentine joint edges of the first and second pieces with a brazing material selected from among copper, bronze, gold, silver, and nickel; and
forming a cutting edge on the first piece.

6. The method of claim 5 wherein forming the first piece comprises laser cutting the first piece from the sheet of the first material.

7. The method of claim 6 wherein forming the second piece comprises fine blanking the second piece from the sheet of the second material.

8. The method of claim 5 wherein the sheet of the first material has a thickness that is thinner than a thickness of the sheet of the second material.

9. The method of claim 5 wherein brazing the first piece to the second piece comprises applying a brazing material to a joint region of the first and second pieces and heating the first and second pieces to a brazing temperature exceeding a liquidus temperature of the brazing material.

10. The method of claim 9, comprising:
cooling the composite blade from the brazing temperature to an austenizing temperature of the first material; and
quenching the composite blade.
